(19) United States
(12) Patent Application Publication
(10) Pub. No.: US 2006/0282946 A1
(43) Pub. Date: Dec. 21, 2006

(54) Patient transfer device

(76) Inventor: Matthew Earl Meyer, Bountiful, UT (US)

Correspondence Address: RANDALL B. BATEMAN;BATEMAN IP LAW GROUP, 8 EAST BROADWAY, SUITE 550, PO BOX 1319, SALT LAKE CITY, UT, 84110, US

(21) Appl. No.: 11/453,290

(22) Filed: Jun. 14, 2006

Related U.S. Application Data
(60) Provisional application No. 60/690,534, filed on Jun. 15, 2005.

(51) Int. Cl. A61G 7/10

(52) U.S. Cl. 5/81.1 HS; 5/601

(57) ABSTRACT

A patient transfer device allows diagnostic testing such as X-rays, MRI, CAT scans, etc. to be performed upon a patient while the patient remains on the transfer device. Such a device allows a patient, and especially an injured patient, to remain on the same transfer device during transport to a hospital or care center, to and from a room or a waiting area, to and from a testing area, and to and from a treatment area, eliminating the need to repeated move the patient onto and off of conventional transport devices or beds. Allowing the patient to remain on the same transport device relatively undisturbed minimizes any further injury to the patient caused by repeated movement of an injured body part.

### BACKGROUND OF THE INVENTION

1. Related Applications

The present application claims the benefit of U.S. Provisional Application Ser. No. 60/690,534, filed Jun. 15, 2005, which is incorporated herein in its entirety.

2. The Field of the Invention

The present invention relates to a patient transfer device. More specifically, the present invention relates to a patient transfer device which allows diagnostic testing such as imaging using X-rays to be performed upon the patient without removal of the patient from the transfer device.

3. State of the Art

Medical and veterinary staff often find it necessary to move patients from one bed or location to another. Several devices exist for the purpose of making these activities easier, and have the added benefit of reducing friction and the mechanical force required to move a patient from one surface to another. It is however appreciated that moving an injured patient is often harmful or somewhat risky to the patient as further injury may occur. This is especially the case where an injury involves broken bones or damaged tissue.

Patients, and in particular patients that are incapacitated and cannot move, are often placed on a widely used and commonly known plastic transfer boards. The transfer boards are used to transport a patient to a hospital or care facility, to and from beds, examination beds and tables, diagnostic machines, etc. Patients which are being treated at a hospital or care facility are often required to have x-ray films taken of a certain body part. The patient is typically transferred to a more specialized X-ray table.

The placement of films under the patient, and also the transfer of patients from surface to surface pose several significant problems for the patient and or medical staff. The patient is typically not capable of moving under their own power if a transfer board is being used, and movement of the patient to and from a transfer board is not easy for medical personnel. Movement of the patient may damage injured body parts, cause the patient pain, or otherwise aggravate a medical problem.

It is easily appreciated that a problem exists with the current means of patient transport, in particular relating to Emergency Medical Services, and the backboards by which they transport patients. For example, a patient is placed on a backboard, in the field, and then is transferred repeatedly from surface to surface or even from board to board within the hospital setting. The patient may be repeatedly moved between the EMS backboard, hospital bed, hospital transfer board, examination bed, surgery bed, etc. The number of times which a patient may be moved increases discomfort and risk of bodily injury to the patient.

Also, a problem exists with current transfer boards in that the handles that are attached to the transfer board frequently get in the way and hinder movement of a patient onto and off of the transfer board. A further problem also exists with current transfer boards in that the transfer/transport boards are not comfortable for patients which may spend extended amounts of time resting on them. Discomfort, and possibly tissue damage such as bruising or ulceration, may occur when a person remains in one position

There is thus a need for a patient transfer device which overcomes the limitations of available devices and methods for transferring patients and performing diagnostic tests upon the same. Specifically, there is a need for a patient transfer device which allows a patient to remain on the device during transfer or transport, and during diagnostic testing such as X-rays.

### SUMMARY OF THE INVENTION

It is an object of the present invention to provide an improved patient transfer (or transport) device and method for using the same.

According to one aspect of the invention, a patient transfer device is provided which provides greater comfort for a patient on the device. The device may be constructed with flexible materials which allow the device to conform somewhat to the patient's body. Additionally, a device may be constructed which provides a padded surface for the patient to rest on.

According to another aspect of the invention, a transfer device may be provided which allows diagnostic testing such as X-rays or MRIs to be performed on the patient without removing the patient from the device. The device may be constructed from a material which does not block or otherwise hinder the diagnostic test. Thus X-rays, for example, may pass through the device so as to allow X-ray images to be taken of the patient while on the transfer device. The X-ray film may be placed below the device, or in pockets or openings in the device. The device may also have an arm or other means for holding X-ray film or the like to the side of or in a desired position around a patient on the device, allowing X-ray images to be created of virtually any part of the patient's body without moving the patient from the transport device or otherwise adjusting the position of the patient.

According to another aspect of the invention, a transport device is provided which provides sufficient rigidity for transporting a patient while at the same time allowing the performing of diagnostic tests such as taking X-rays while the patient is on the device. The transport device may be formed with multiple layers to thereby increase the rigidity of the device. The device may also be formed with reinforcing structures such as ribs or channels to thereby increase the rigidity.

According to another aspect of the invention, a transport device may be provided which is formed with retractable handles. The handles may be extended or otherwise positioned to allow medical personnel to move the device and patient, and retracted to allow for storage, diagnostic testing, etc.

These and other aspects and advantages of the present invention are realized in a patient transfer device as shown and described in the following figures and related description.

### BRIEF DESCRIPTION OF THE DRAWINGS

Various embodiments of the present invention are shown and described in reference to the numbered drawings wherein:

FIG. 1 shows a top view of a patient transport device of the present invention;

FIG. 2 shows a top view of a patient transport device of the present invention;

FIG. 3 shows a side view of a patient transport device of the present invention;

FIG. 4 shows a partial side view of a patient transport device of the present invention;

FIG. 5 shows a partial view of a patient transport device of the present invention;

FIG. 6 shows a top view of a slider of the present invention;

FIG. 7 shows a perspective view of a slider of the present invention;

FIG. 8 shows a top view of a slider of the present invention;

FIG. 9 shows a partial top view of a slider of the present invention;

FIG. 10 shows a partial top view of a slider of the present invention;

FIG. 11 shows a side view of a slider of the present invention;

FIG. 12 shows a side view of a patient transport device of the present invention;

FIG. 13 shows a side view of a patient transport device of the present invention;

FIG. 14 shows an end view of a patient transport device of the present invention;

FIG. 15 shows a top view of a patient transport device of the present invention;

FIG. 16 shows a perspective view of an arm of a patient transport device of the present invention;

FIG. 17 shows a perspective view of a patient transport device of the present invention;

FIG. 18 shows a top view of a patient transport device of the present invention;

FIG. 19 shows a partial perspective view of a patient transport device of the present invention;

FIG. 20 shows a side view of a patient transport device of the present invention;

FIG. 21 shows a bottom view of a patient transport device of the present invention;

FIG. 22 shows a perspective view of a reinforcing structure of the present invention;

FIG. 23 shows a top view of a patient transport device of the present invention;

FIG. 24 shows a top view of a patient transport device of the present invention;

FIG. 25 shows a cross sectional view of a patient transport device of the present invention;

FIG. 26 shows a top view of a patient transport device of the present invention;

FIG. 27 shows a top view of a patient transport device of the present invention;

FIG. 28 shows a partial cutaway view of a patient transport device of the present invention;

FIG. 29 shows a top view of a slider of the present invention;

FIG. 30 shows a cross sectional view of a patient transport device of the present invention;

FIG. 31 shows a bottom view of a patient transport device of the present invention;

FIG. 32 shows a bottom view of a patient transport device of the present invention;

FIG. 33 shows a bottom view of a patient transport device of the present invention;

FIG. 34 shows a top view of a patient transport device of the present invention;

FIG. 35 shows a top view of a handle of a patient transport device of the present invention;

FIG. 36 shows a perspective view of a handle of a patient transport device of the present invention;

FIG. 37 shows an end view of a handle of a patient transport device of the present invention;

FIG. 38 shows an end view of a handle of a patient transport device of the present invention;

FIG. 39 shows a perspective view of a handle of a patient transport device of the present invention; and

FIG. 40 shows a perspective view of a handle of a patient transport device of the present invention.

It will be appreciated that the drawings are illustrative and not limiting of the scope of the invention which is defined by the appended claims. The various embodiments shown accomplish various aspects and objects of the invention. It is appreciated that not all aspects of the invention may be clearly shown in a single figure. Thus, multiple figures may be used to illustrate the various aspects of a single embodiment of the invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

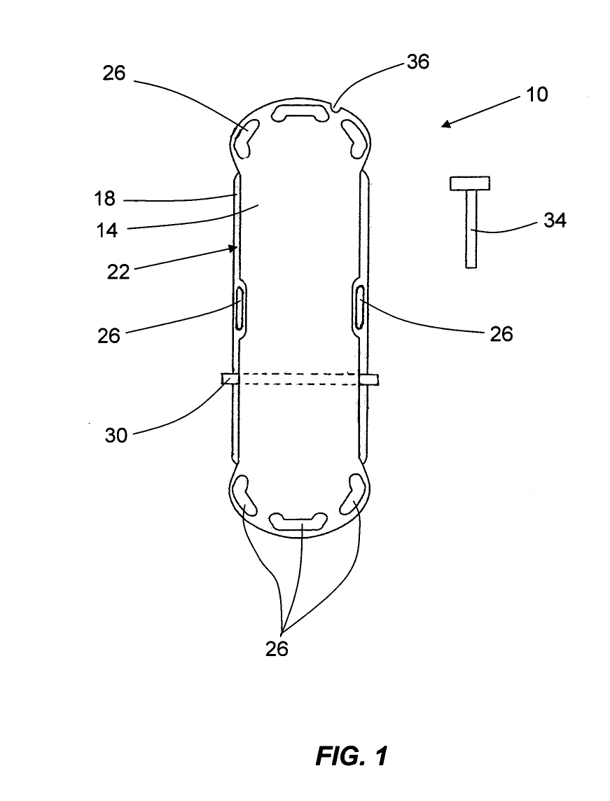

Turning now to FIG. 1, a top view of a patient transport device according to the present invention is shown. The transport device is typically the size of a person, and may be about 6 feet long and about 2 feet wide. Other sizes may be formed for children, animals, etc. The transport device 10 is formed with an upper layer 14 and a lower layer 18 having an opening 22 formed therebetween. The upper layer 14 and lower layer 18 are typically joined at various locations along the transport device (such as the ends and possibly in the central portion) to thereby form a unitary device of sufficient rigidity to carry a patient. The opening 22 allows for the insertion of X-ray film between the upper layer 14 and lower layer 18 for diagnostic testing, as will be discussed in greater detail.

The transport device 10 is typically formed with handles 26 formed therein to facilitate carrying the transport device and thereby transporting a patient. The handles 26 may be formed in the upper layer 14, lower layer 18, or both. It is appreciated that the locations of the handles 26 are often chosen to best support the weight of the patient along the device 10, and as such it is common to form handles on the ends of the device and in the center of the sides of the device.

A significant purpose of the present invention is to provide a transport device which does not interfere with diagnostic testing such as X-rays, MRI, CAT scans, etc. As such, the device must be made of appropriate materials and in appropriate thicknesses and shapes to not interfere with such tests. Typically, the transport device is made with materials which allows transmission of a significant amount of the testing rays, etc. through the device. Herein, the term “radio translucent” is used to denote materials and construction which allows substantial transmission of the waves or frequencies used for X-rays, MRI, CAT scans, and the like. Such materials may include plastics and other materials which do not significantly occlude the testing rays. It is commonly known that many materials will transmit a substantial portion of these desired testing waves when relatively thin, but will not transmit sufficient amounts of the testing waves when too thick. Thus, radio translucent as used herein means that the desired areas of the patient transport device are constructed of an appropriate material at an appropriate thickness so as to not interfere with diagnostic testing such as X-rays, MRI, CAT scans, etc. It is appreciated that one material may be suitable for X-rays, where another material is better suited for different types of tests. It is also appreciated that many materials such as metals will block or otherwise significantly interfere with these testing rays even when very thin, and as such are not within the definition of radio translucent and are inappropriate for forming the body of the transport device.

Even materials such as plastics will interfere with these testing rays if they are too thick. As such, the device is typically formed with layers of materials which are thin enough to not significantly interfere with testing. One suitable material is polypropylene. The device 10 may be formed with a relatively thin (often between 1 inch and ⅛ of an inch, and more often about ⅜ or ¼ of an inch) upper layer 14 and lower layer 18, both formed of polypropylene. The device may alternatively be formed of other materials or combinations of materials. It is appreciated that the X-rays need only pass through the upper layer 14 relatively unobstructed if the X-ray film is placed between the upper layer and the lower layer 18, and as such the lower layer may be thicker for strength.

It is appreciated that many other materials such as polyethylene, acrylic, etc. may be selected based upon desired characteristics such as optical clarity, strength, resilience, etc. so long as the material does not interfere with the desired testing. Thus, the device may be formed with a combination of different materials.

The transport device 10 may also typically include a sliding mechanism 30 (a “slider”). The sliding mechanism or slider may be used to facilitate the placement of X-ray film or the like between the upper layer 14 and lower layer 18. As the upper layer 14 is commonly formed of relatively thin plastic, the weight of patient on the transport device will bend the upper layer into contact with the lower layer. The slider 30 is disposed between the upper layer 14 and lower layer 18 and may be used to open or widen the opening 22 between the upper layer and lower layer to facilitate the placement of X-ray film or the like. Additionally, a T handle 34 or other pushing and/or pulling device may be included to further facilitate the placement of the film in the opening 22. The bottom layer 18 may extend beyond the top layer 14 to allow for easier placement of X-ray film, etc.

A notch 36, in addition to holes or the like, may be formed in the transport device 10 to allow for easy attachment of medical equipment, such as endotracheal tubes, monitoring lines, IV lines, mounting poles, and the like. Such equipment may be attached to the transport device by bolts, bands, straps, hook and loop fasteners, snaps, etc.

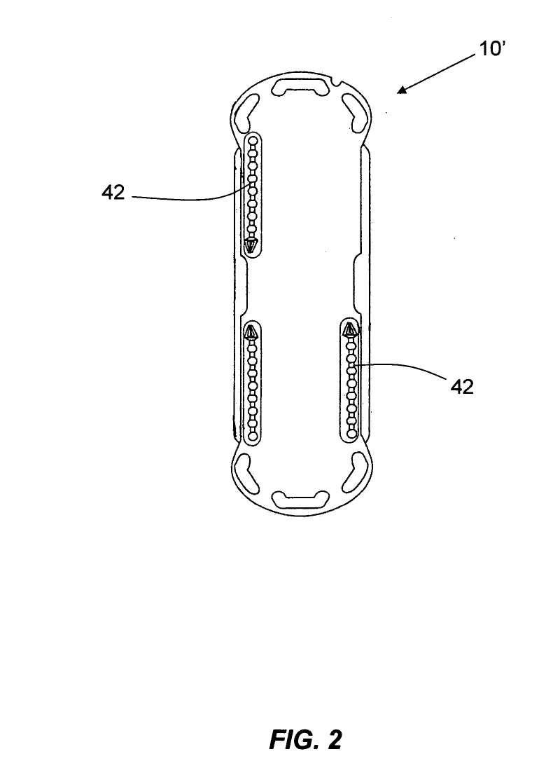

FIG. 2 shows a top view of an alternate patient transport device 10′ which is similar to that of FIG. 1 except that it has arms 42 which are configured to receive and hold in a desired position X-ray film or the like. It is appreciated that the arms 42 may be formed in a variety of different shapes, and are typically configured to position X-ray film adjacent the transport device to allow for taking of X-ray images of the patient from a variety of angles.

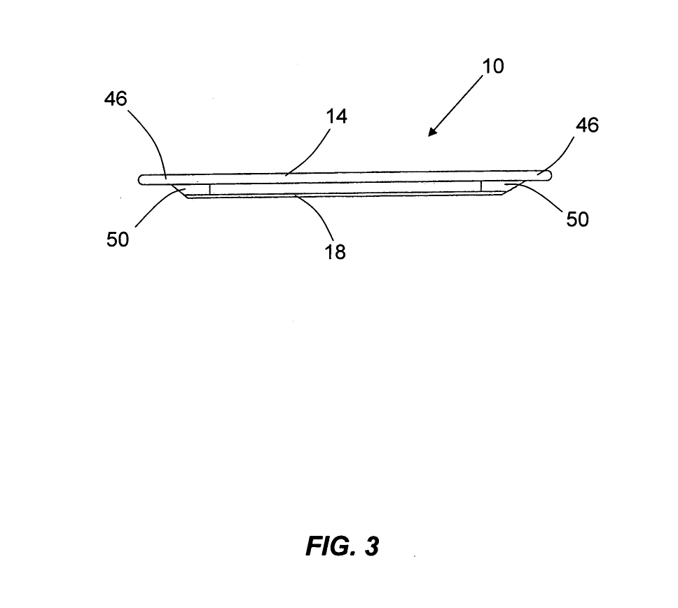

FIG. 3 shows a side view of the device 10 of FIG. 1. It is seen that the upper layer 14 and lower layer 18 are joined at the ends 46 of the transport device. Joiner pieces 50 may be used to create a space 22 between the upper layer 14 and lower layer 18. It can be also seen that the upper layer 14 and lower layer 18 need not be the same thickness. One may be thicker than the other. The slider is not shown for clarity.

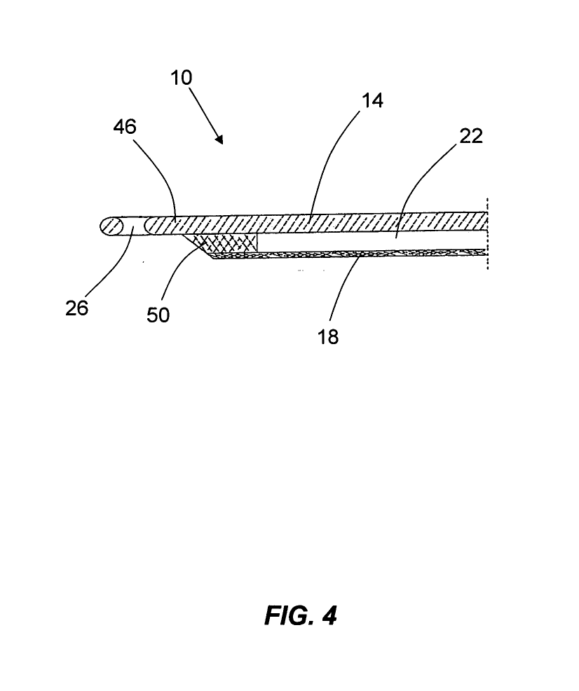

FIG. 4 shows a cross sectional view of an end 46 of the patient transport device 10 of FIG. 1. It can be seen how a handle 26 is formed in the upper layer 14. It is also appreciated that the upper layer 14 need not extend so far, and the handle 26 may thus be formed in the upper layer 14, lower layer 18, and joiner piece 50.

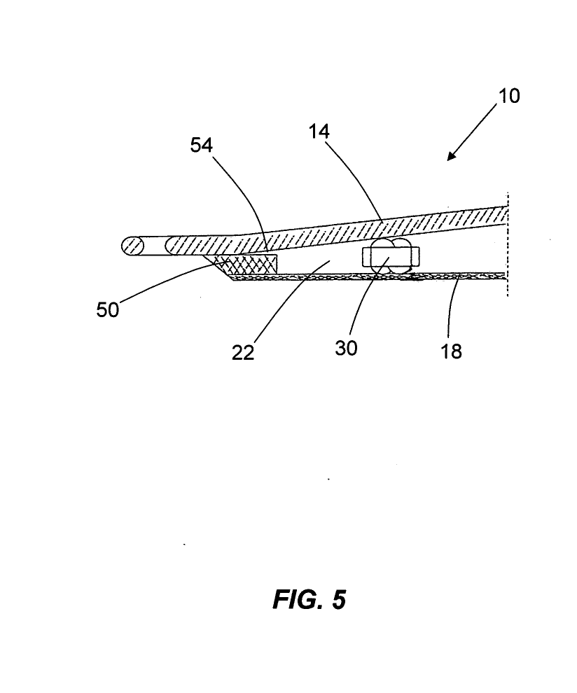

FIG. 5 shows a partial cross sectional view of an end 46 of the patient transport device 10 of FIG. 1. It can be seen how the slider 30 is used to aid in the formation of the opening 22 between the upper layer 14 and lower layer 18. The slider 30 may be made slightly thicker than the opening 22 as shown, or may be made slightly thinner or the same thickness as the opening as is desired. The upper layer 14 may be slightly unattached as shown at 54 to facilitate placement of an X-ray film close to the end of the opening 22.

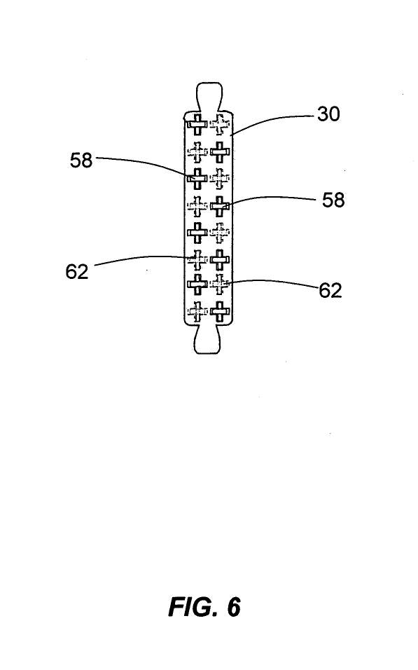

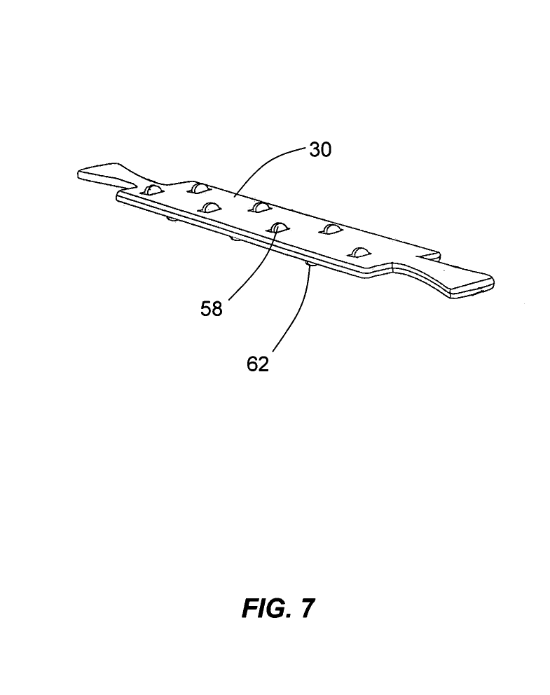

FIG. 6 shows a top view of the slider 30 of FIG. 1. The slider 30 may be formed with bearings (termed bearings, these are typically rollers or wheels) 58, and may include wheels which only extend from the top, and wheels 62 which only extend from the bottom to allow the slider to move easily. Such top wheels 58 and bottom wheels 62 may be arranged in an alternating pattern. FIG. 7 shows a perspective view of the slider of FIG. 6.

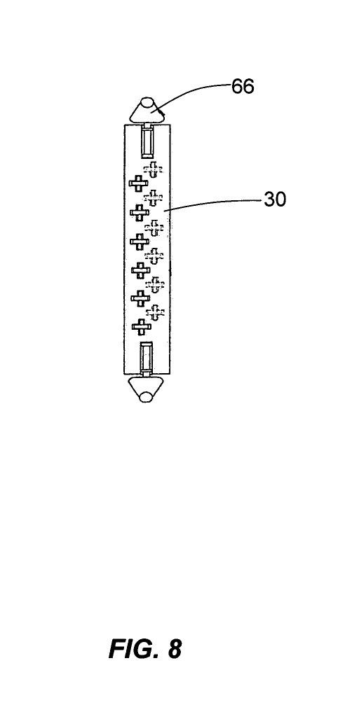

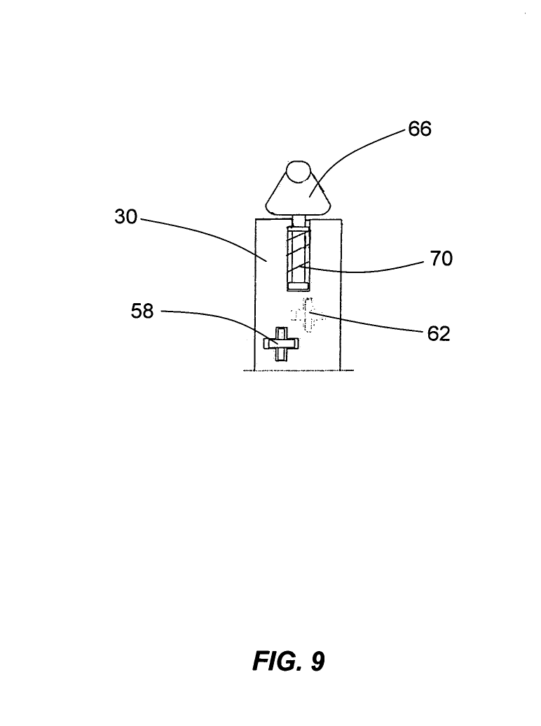

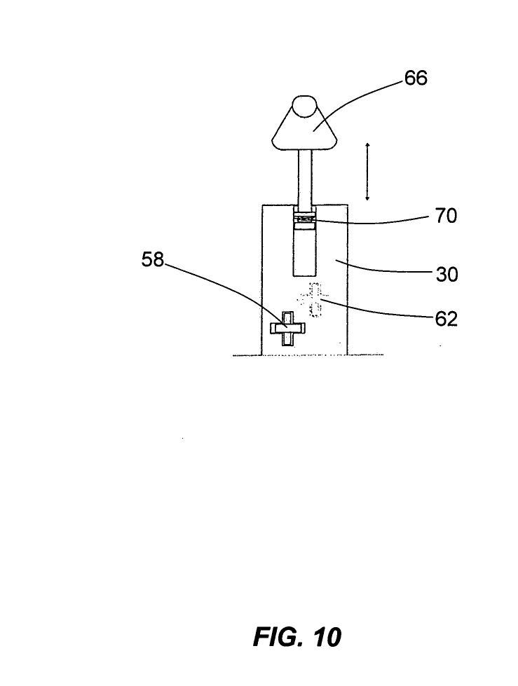

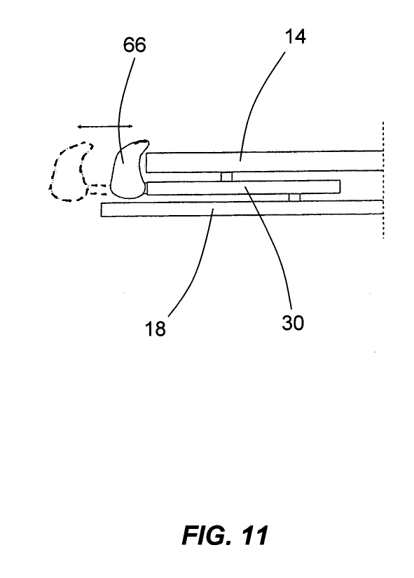

FIG. 8 shows a top view of an alternate construction of slider 30 of FIG. 1 where the slider 30 has retractable handles 66. FIG. 9 shows a detail of FIG. 8, showing how a spring 70 or other biasing device may be used to bias the handle 66 towards the slider 30. FIG. 10 shows another view of the handle 66 in an extended position. FIG. 11 shows a side view of the slider 30 of FIG. 8, showing the extension and retraction of handle 66.

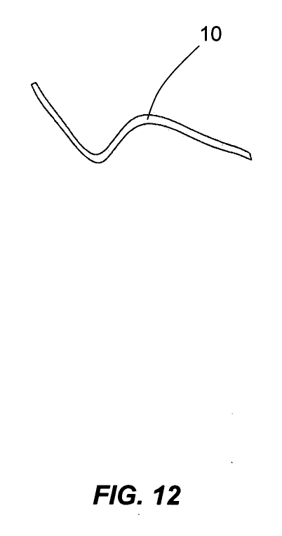

FIG. 12 shows a side view of the transport device 10 of FIG. 1. The transport device 10 may be made somewhat flexible (shown exaggerated here) so as to conform somewhat to a patient's body, increasing the patients comfort. Such flexing and conformation may occur where a patient is kept on a transport device even when on a bed so as to facilitate transportation for X-ray or other testing without lifting the patient off the bed and onto a transport device. Keeping the patient on a transport device during periods of moving a patient to a hospital or care center, waiting, testing, etc. may minimize unintentional bending or moving of the patient's body, thereby minimizing the risk of additional injury.

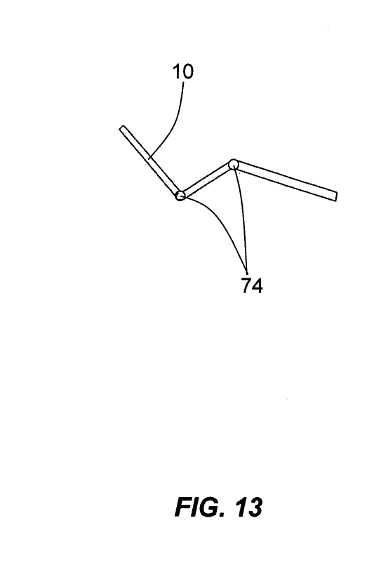

FIG. 13 illustrates how the transport device 10 of FIG. 1 may be formed with hinged joints 74 to facilitate some bending as discussed above.

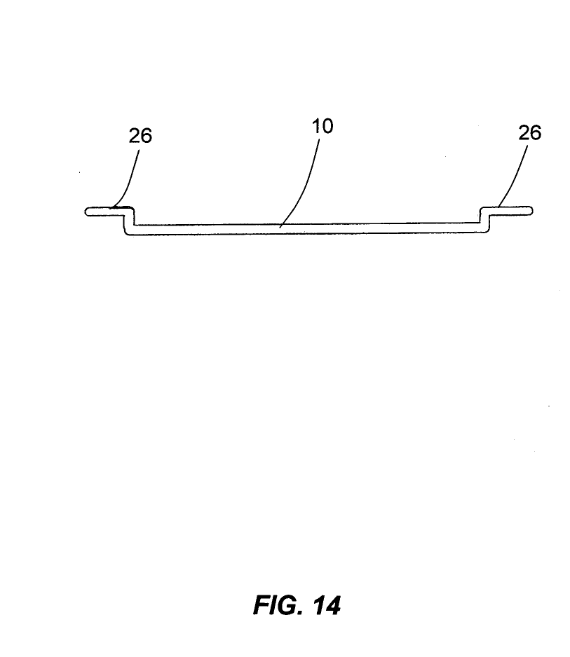

FIG. 14 shows a cross sectional view of the transport device 10 of FIG. 1 and illustrates how the device may be formed with elevated handles 26, or elevated side walls, to facilitate movement of the transport device or to increase the resistance of the transport device to bending.

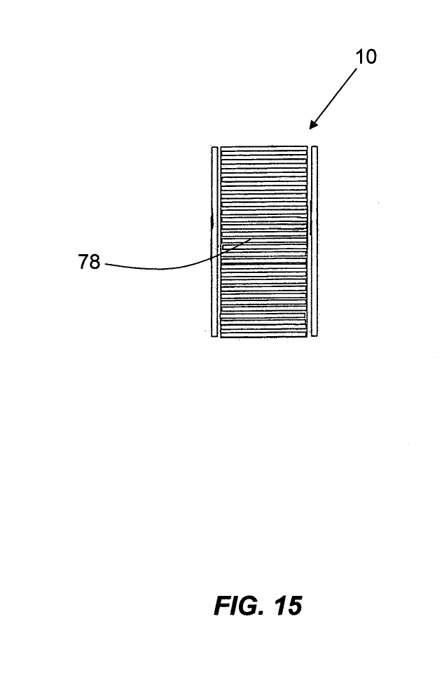

FIG. 15 illustrates how the transport device may be formed with a lattice 78 if such is desired to increase patient comfort. Such should be accomplished with minimal impact on the ability to perform X-ray imaging and other diagnostic testing.

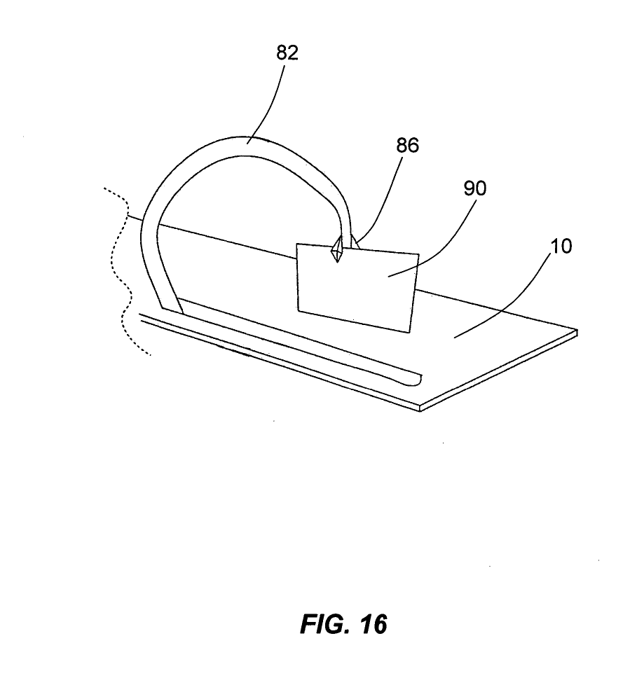

FIG. 16 shows a perspective view of the transport device 10 of FIG. 1, illustrating how an arm 82 may be attached to the device 10. The arm 82 is not shown in FIG. 1 for clarity. The arm 82 may be a flexible arm, or a hinged arm, etc. and typically includes a clamp 86 or other means for holding a piece of X-ray film 90 or other necessary diagnostic equipment or supplies. Thus, the arm 82 allows an X-ray to be taken of areas or views of a patient without moving the patient. For example, a top view of the patient's arm may be taken by placing the film under the patient in the opening (22, FIG. 1) and a side view may be taken by using arm 82 to position the film nest to the patient's arm. The device thus allows X-rays or other diagnostic testing to be performed from a variety of directions without repositioning the patient. The various structures detailed in FIG. 1 are not shown in this figure for clarity, but are understood to be part of the Figure.

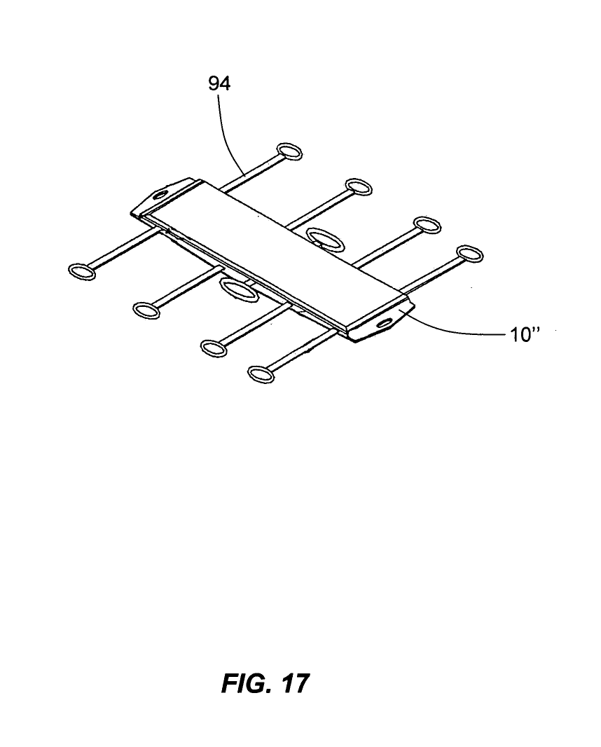

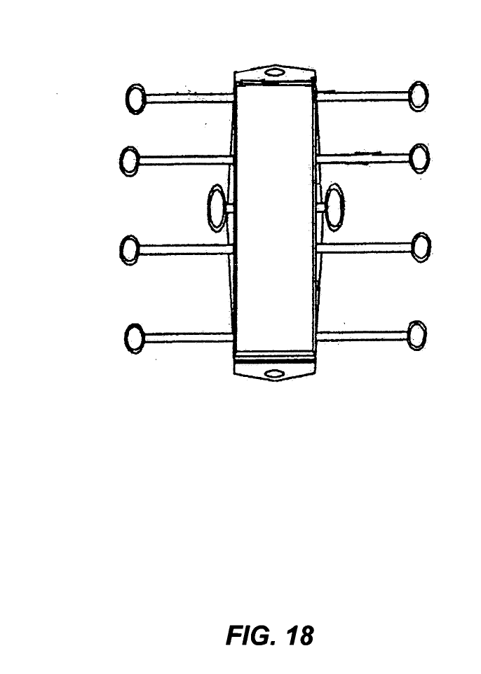

FIG. 17 shows a perspective view of an alternate configuration of the transport device 10″ of FIG. 1. The transport device 10″ includes a plurality of extendable handles 94. The handles 94 may extend and retract into the body of the device 10″. Alternatively, extension handles 94 may be formed with flexible straps connected to handle portions. FIG. 18 shows a top view of the patient transport device 10″ of FIG. 17.

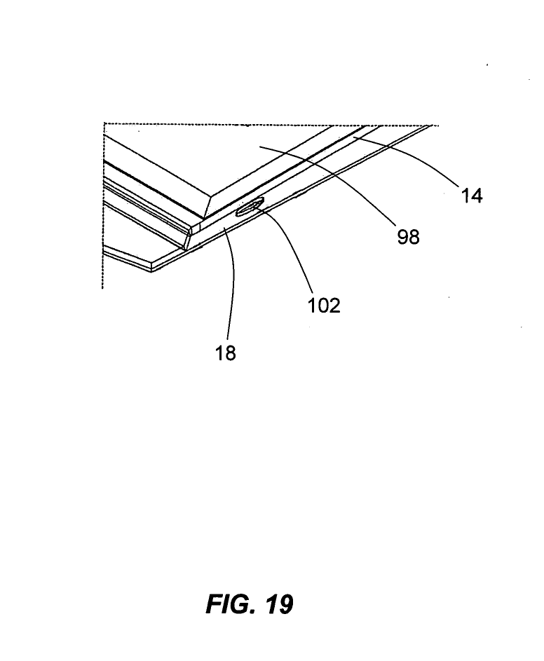

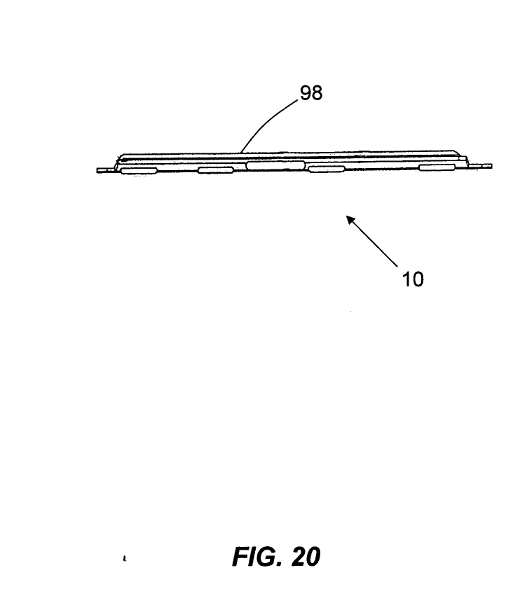

FIG. 19 shows a detailed perspective view of a possible construction method for the transport devices previously shown (device 10 of FIG. 1, device 10′ of FIG. 2, device 10″ of FIG. 17). The transport device may be formed with a layer of padding 98 attached to the upper layer 14. The padding 98 will typically be a foam such as polyurethane. The padding 98 may significantly add to patient comfort while having a minimal effect on any interference the device would have on diagnostic testing. The device may also be constructed with attachment points 102 for removably attaching handles to the device. FIG. 20 shows a side view of the construction method of FIG. 19, illustrating how the padding 98 would typically extend across the upper surface of the device.

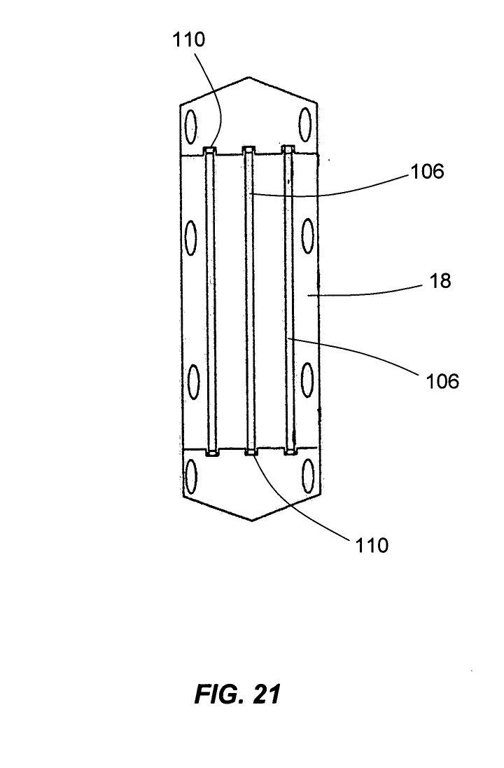

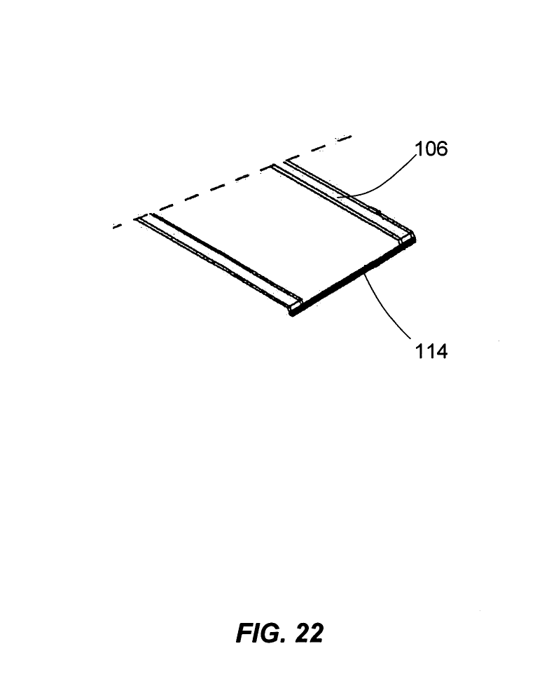

FIG. 21 shows a bottom view of a transport device (10, 10′, 10″), illustrating how the lower layer 18 of the device may be alternatively formed with channels or ridges 106 extending along the device, or formed with a lateral support assembly 106 attached to the device at attachment points 110. FIG. 22 shows a perspective view of the lateral support assembly 106 of FIG. 21, illustrating how transverse support members 114 may be attached to the lateral support assembly 106, and integrated into the device.

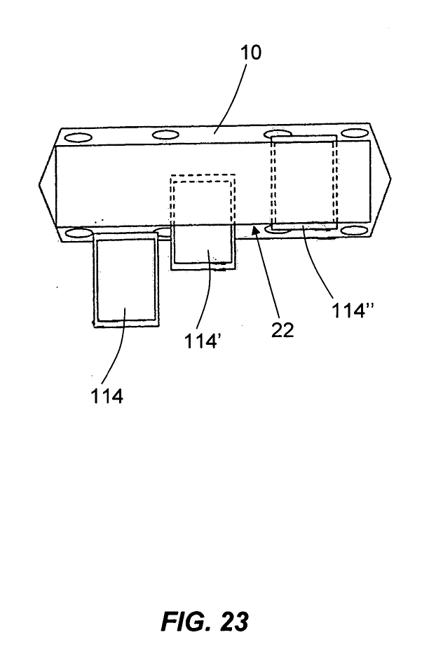

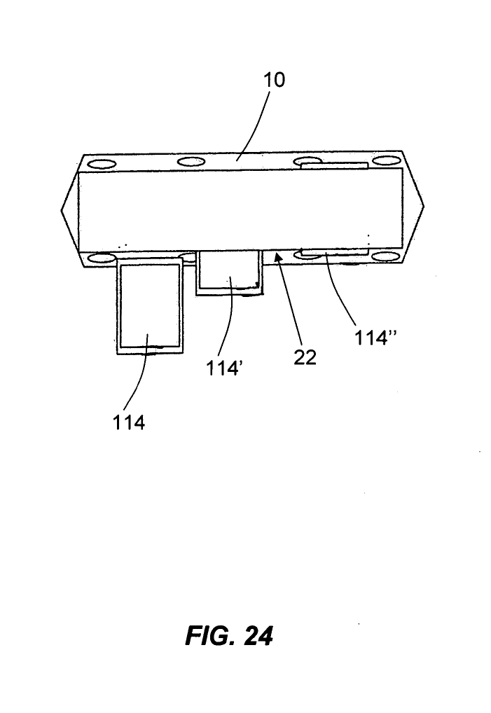

FIG. 23 shows a top view of the patient transport device 10 (it will be appreciated that this discussion applies to all of the devices shown herein 10, 10′, 10″) illustrating how the transport device 10 may receive X-ray film 114, 114′, 114″ or other diagnostic equipment or supplies. The film 114 may be inserted into the opening 22 in the device 10, and may be inserted to any desired depth and at any desired position along the device. The slider (30, FIG. 1, not shown) may be used to aid in opening the opening 22 and creating a space to receive the film 114. FIG. 24 shows another top view of the device 10 as shown in FIG. 23. It is thus appreciated that the device allows X-rays and other diagnostic test to be performed without unnecessarily moving the patient from bed to bed or surface to surface.

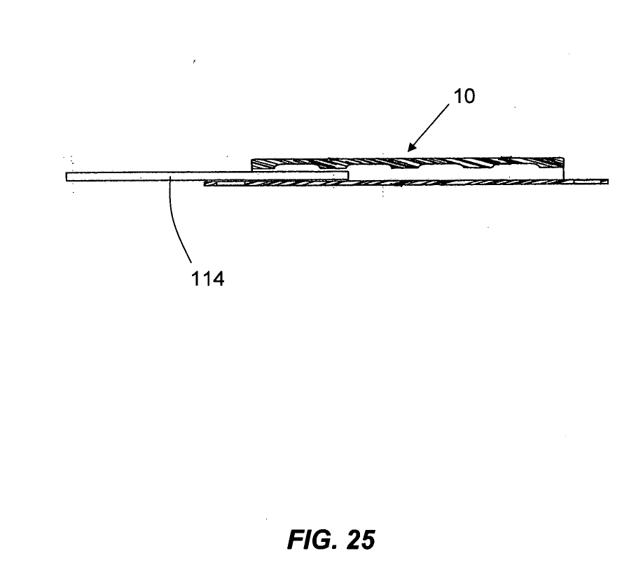

For performing X-rays and similar procedures, the patient is typically transported to a hospital and throughout a hospital on a transport device 10, and often remains on the transport device until testing is completed. The patient is brought to a testing room and the patient and transport device are placed on a testing bed or table. X-ray film or the like are inserted into a desired location along the opening of the device and X-rays are taken. The arm previously shown may be used to take additional X-rays from different directions or along portions of the patient's body which are not accessible through the transport device. The transport device is constructed of appropriate types and thicknesses of material to not interfere with these tests. The patient may then be transported on the device to a desired room, operation room, etc. The device minimizes unnecessary moving of the patient onto and off of surfaces alone, which places much more stress on the patient's body. The above process is similar for MRI or CAT scans or other tests, with the exception that the patient and transport device may be placed together inside of a testing or imaging machine. The transport device is typically constructed of types and thicknesses of material which does not interfere with these tests. FIG. 25 shows a cross sectional view of an X-ray film 114 being inserted into the transport device 10.

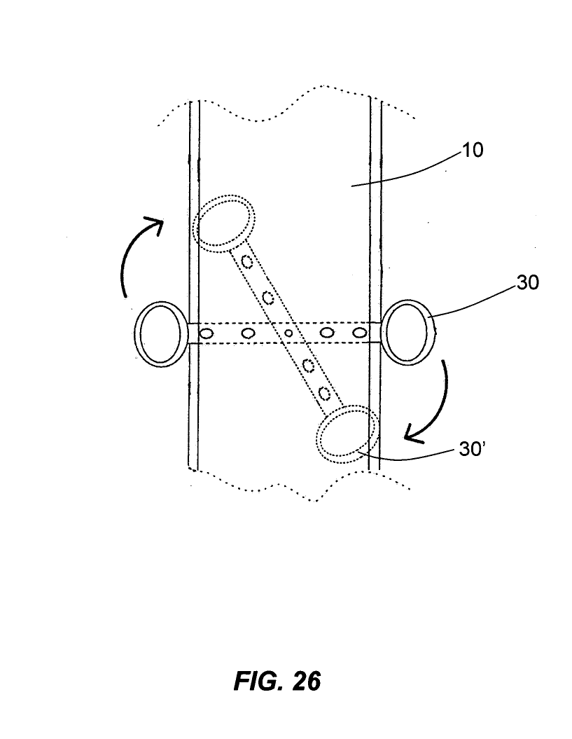

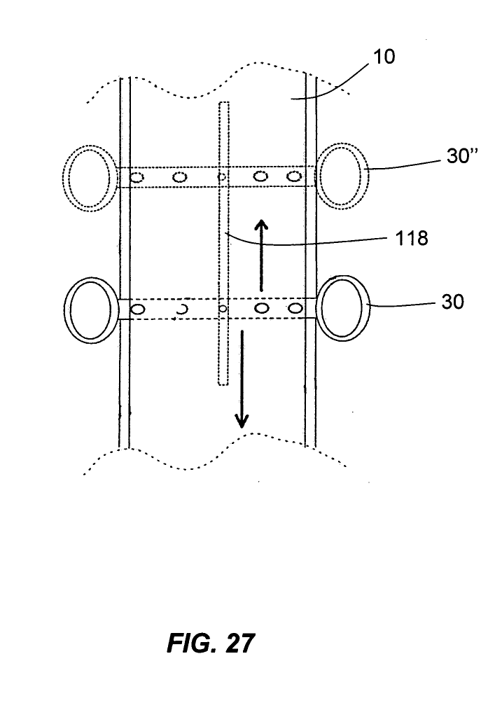

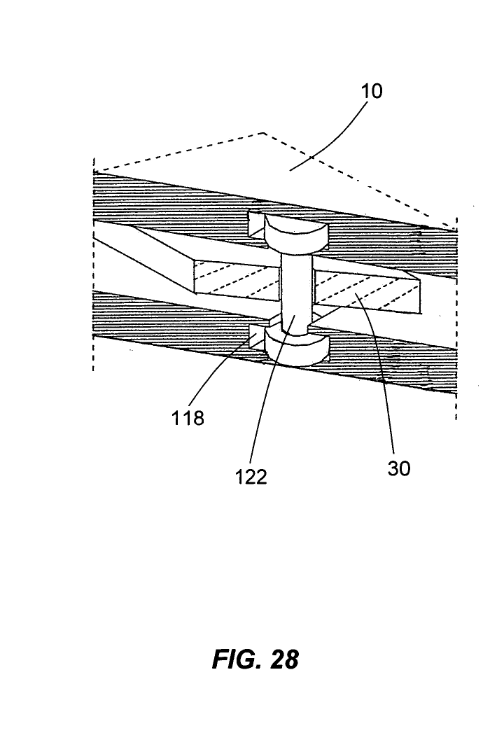

FIG. 26 shows a top view of a transport device 10 and a style of slider 30 as have been discussed previously. It is illustrated how the slider may be constructed for easy rotation as well as sliding linearly, allowing the slider 30 to pivot as shown (30′). FIG. 27 shown another top view of the transport device 10 and slider 30 of FIG. 26, illustrating how the slider may move along a slot 118 which maintains the slider centered in the transport device. FIG. 28 shows a cut away detailed view of the transport device 10 and slot 118 shown in FIG. 27, illustrating how the slider 30 may have a pivot 122 which keeps the slider in the slot and allow for linear movement of the slider along the slot and for pivoting of the slider.

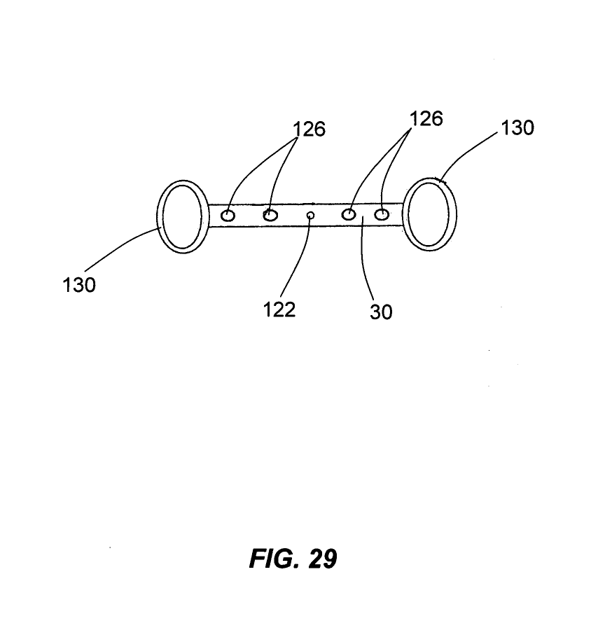

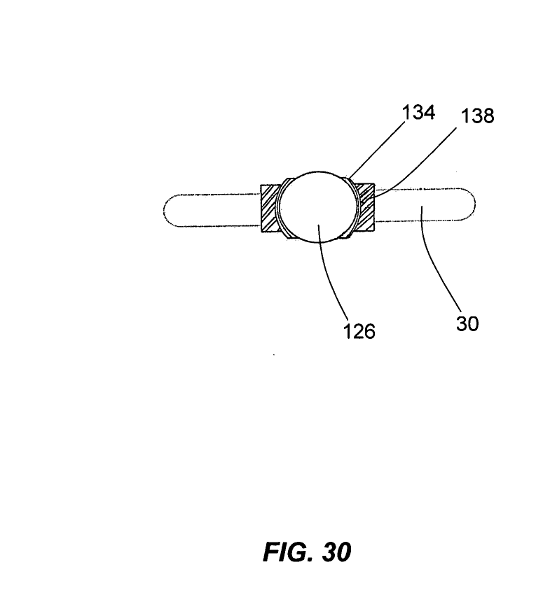

FIG. 29 shows a detailed view of the slider 30 of FIG. 27, illustrating how the slider may be formed with the pivot 122, bearings or wheel assemblies 126 which allow easy movement of the slider, and handles 130 to facilitate movement of the slider, and if so designed, for carrying of the transport device 10 (not shown). FIG. 30 shows a detailed cross sectional view of the slider 30 of FIG. 27, showing how the bearing 126 may be a ball captured in the slider 30, and may include a bearing housing 134 or additional support 138. Alternatively, the bearing may be a wheel or ball type bearing which extends only from one side of the slider 30 as previously shown, and may thus include multiple bearings alternatively extending from either side of the slider.

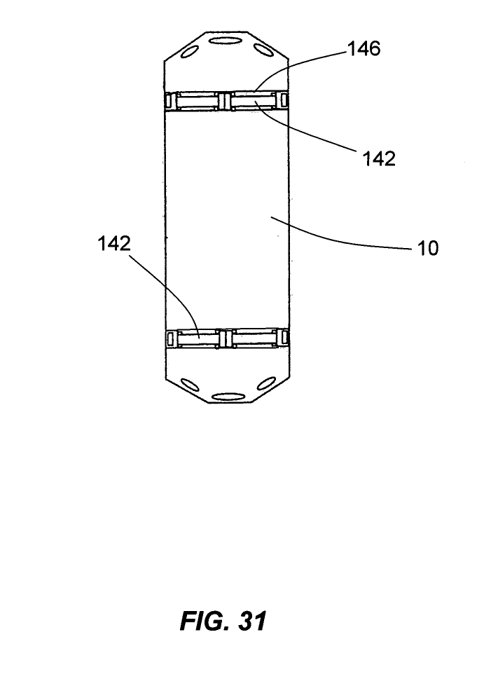

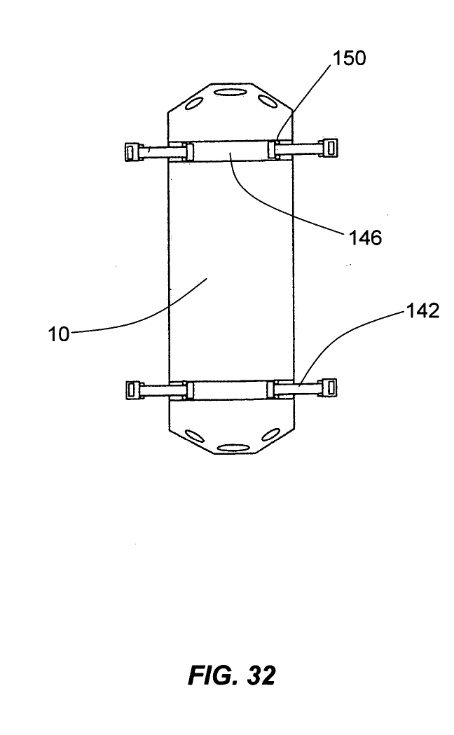

FIG. 31 shows a bottom view of a transport device 10 illustrating how retractable handles 142 may be attached to the transport device. The handles 142 may be disposed in channels or slots 146 and slide in the channels or slots. FIG. 32 further shows the handles 142 of FIG. 31, illustrating how the handles are extended, and how the slots 146 may be formed with stops 150 to limit the extension of the handles.

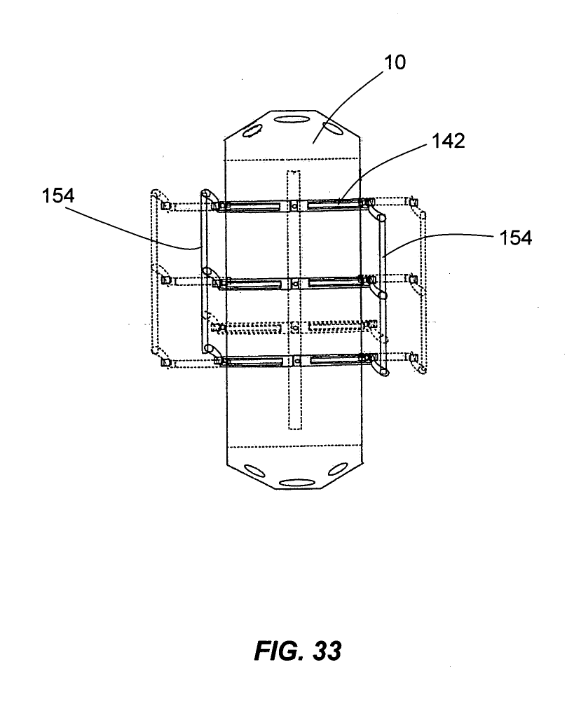

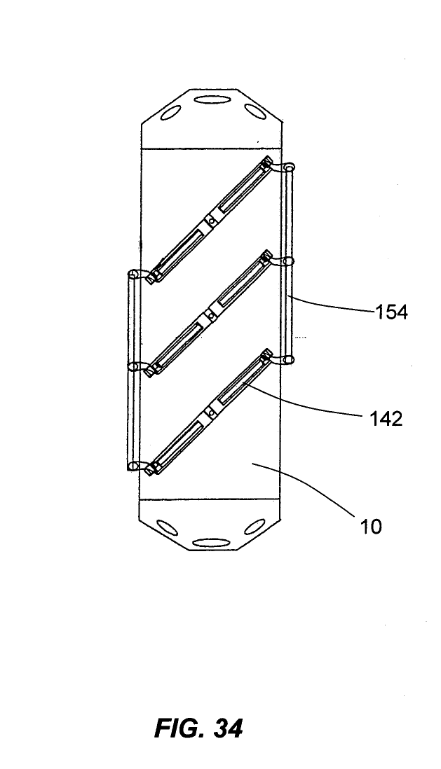

FIG. 33 further illustrates the retractable handles 142 of FIG. 31, illustrating how the retractable handles may be attached to a carrying frame or handle extension 154. FIG. 34 shows another view of the extendable handles of FIG. 33, illustrating how the handles 142 may be pivotably attached to the transport device 10 and the frame or handle extension 154 pivotably attached to the handles 142, allowing the assembly to pivot as shown for convenience in use.

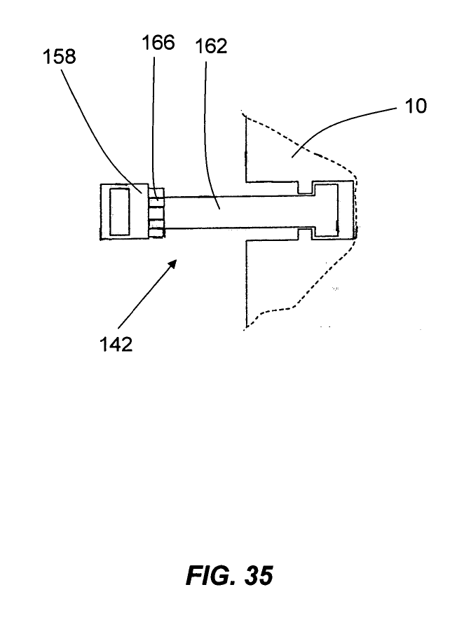

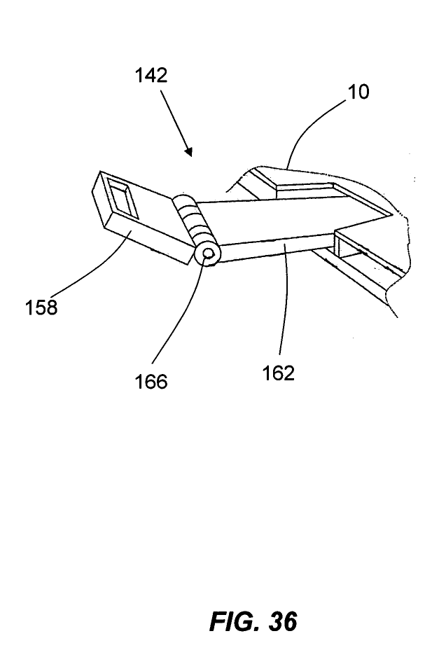

FIG. 35 further illustrates the handles 142 of FIG. 31, illustrating how the handles may comprise a handle portion 158 attached to a handle body 162 by a hinge 166, allowing the handle portion to be bent to a desired position for use. FIG. 36 shows a perspective view of the handle assembly of FIG. 35.

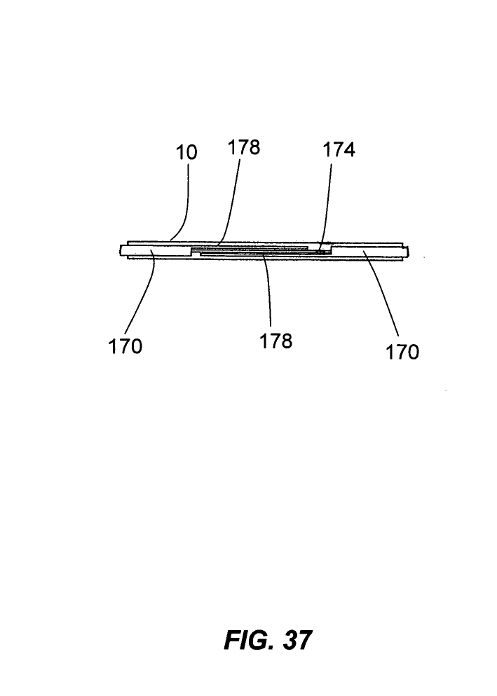

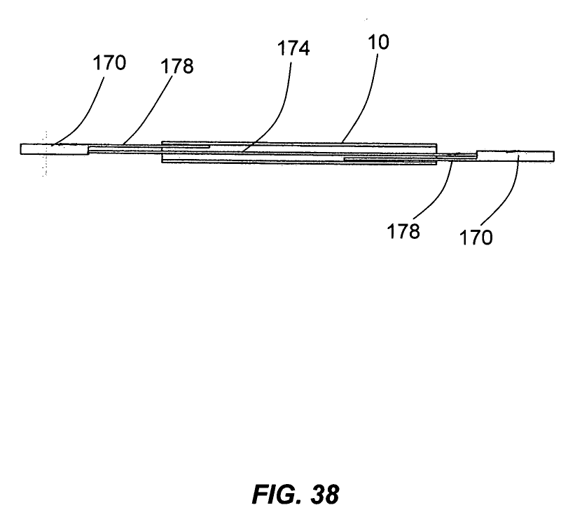

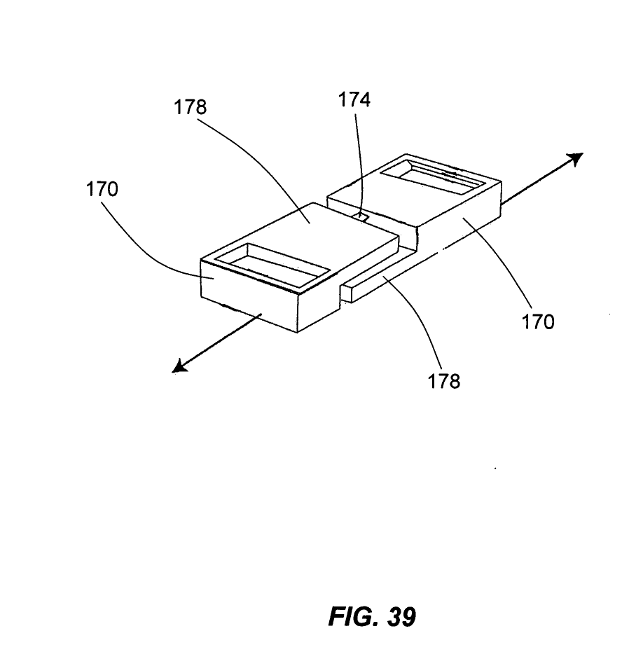

FIG. 37 shows an alternate handle configuration whereby two handles 170 are attached together by a biasing member 174, which may be an elastomeric member or a spring or the like. The biasing member 174 biases the handles 170 into a retracted position. The handles may have overlapping extensions 178 which may strengthen the handles. FIG. 38 shows a view of the handles 170 of FIG. 37 in an extended position, illustrating the biasing member 174 and overlapping extensions 178. FIG. 39 shows a perspective view of the handles 170 of FIG. 37.

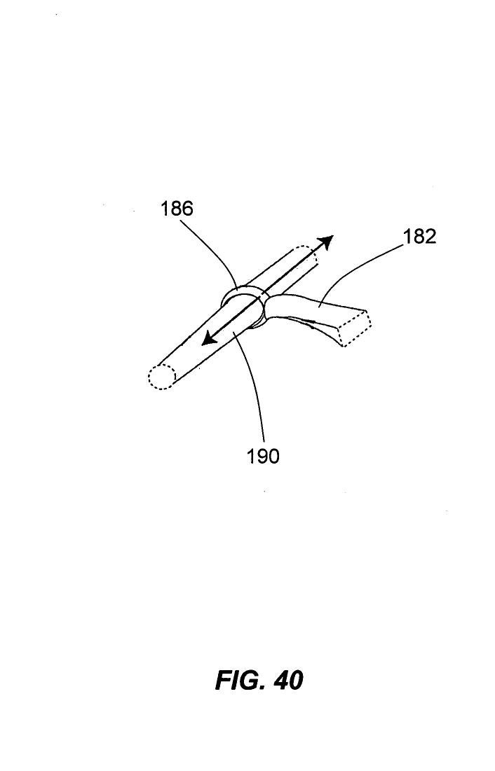

FIG. 40 shows a perspective view of a handle configuration whereby the handle 182 is formed with a ring 186 to either permanently or removably receive a handle extension such as shaft 190. Such a handle extension may pass through multiple handles on the same side of the transport device (any of those shown herein) and form an elongated handle which is easy to use. Additionally, a removable extension shaft 190 may be formed of a rigid material such as steel without concern with interference with diagnostic tests, as it may be removed prior to testing procedures. Such illustrates another principle of the invention, that a transport device may include removable portions for use in transporting the device or in strengthening the device, but which may be removed so as to not interfere with diagnostic testing.

There is thus disclosed an improved patient transfer device. It will be appreciated that numerous changes may be made to the present invention without departing from the scope of the claims.

What is claimed is:

1. A patient transfer device comprising:
an upper layer of radio translucent material configured for receiving a patient thereon;
a lower layer of material attached to the upper layer of material; and
an opening between the upper layer and the lower layer configured for receiving X-ray film or the like.

2. The patient transfer device of claim 1, wherein the lower layer is radio translucent.

3. The patient transfer device of claim 1, wherein the lower layer is attached to the upper layer at the ends thereof.

4. The patient transfer device of claim 1, wherein the lower layer is attached to the upper layer via a joiner piece.

5. The patient transfer device of claim 1, further comprising handles formed in the ends thereof.

6. The patient transfer device of claim 5, further comprising handles formed in the sides thereof.

7. The patient transfer device of claim 6, wherein the side handles are formed only in the lower layer.

8. The patient transfer device of claim 1, wherein the lower layer is wider than the upper layer.

9. The patient transfer device of claim 1, further comprising a slider disposed between the upper layer and the lower layer, the slider being slideable along the length of the opening between the upper layer and the lower layer.

10. The patient transfer device of claim 9, wherein the slider comprises a plurality of rollers.

11. The patient transfer device of claim 1, further comprising a plurality of retractable handles.

12. A patient transfer device comprising:
a generally planar board, the board having an upper surface configured for supporting a patient thereon; and
an opening formed in the generally planar board, the opening extending through a first side of the board, the opening being configured for receiving X-ray film; and
wherein the generally planar board is formed of a material which transmits X-rays therethrough and is configured for taking X-rays of a patient which is lying on the board.

13. The patient transfer device of claim 12, wherein the generally planar board is approximately six feet long and approximately two feet wide.

14. The patient transfer device of claim 12, wherein the opening extends for a majority of the length of the board.

15. The patient transfer device of claim 12, wherein the opening extends through the board and extends through a second side of the board opposite the first side of the board.

16. The patient transfer device of claim 12, further comprising handles formed in the board.

17. The patient transfer device of claim 13 further comprising handles formed in the ends thereof, and further comprising handles formed along the sides thereof.

18. The patient transfer device of claim 16, wherein the opening passes through the board from a first side of the board to a second side of the board.

19. The patient transfer device of claim 12, further comprising at least one arm attached to the board and configured for holding X-ray film adjacent to the board.

20. A method for performing X-ray photography on a patient, the method comprising:
placing a patient on a transport board;
placing an X-ray film underneath at least an upper layer of the transport board; and
passing X-rays through the patient and through the transport board to thereby expose the X-ray film.

21. The method of claim 20, wherein the method further comprises transporting the patient on the transport board.

22. The method of claim 21, wherein the method comprises carrying the transport board.

23. The method of claim 20, wherein the method further comprises placing X-ray film inside of the transport board.
